(19) United States
(12) Patent Application Publication
(10) Pub. No.: US 2012/0079043 A1
(43) Pub. Date: Mar. 29, 2012

(54) METHOD, APPARATUS AND SYSTEM FOR ACCESSING AN APPLICATION ACROSS A PLURALITY OF COMPUTERS

(75) Inventors: Michael Stephen Brown, Kitchener (CA); Herbert Anthony Little, Waterloo (CA); Terrill Mark Dent, Waterloo (CA)

(73) Assignee: RESEARCH IN MOTION LIMITED, Waterloo (CA)

(21) Appl. No.: 13/195,587

(22) Filed: Aug. 1, 2011

Related U.S. Application Data
(60) Provisional application No. 61/386,743, filed on Sep. 27, 2010.

(51) Int. Cl. G06F 15/16

(52) U.S. Cl. 709/206; 709/217

(57) ABSTRACT

A method, apparatus and system for accessing an application across a plurality of computers is provided. In one aspect, a client machine and a mobile computing device are provided. The client machine is configured to execute a browser application. The mobile computing device is configured to host a web server application. When the client machine and the mobile computing device are connected, functions on the mobile computing device become available on the client machine via the interaction between the web server and the browser.

### CROSS REFERENCE TO RELATED APPLICATION

This application claims the benefit of U.S. Provisional Application No. 61/386,743, filed Sep. 27, 2010, the entire content of which is hereby expressly incorporated by reference.

### FIELD

The present specification relates generally to computing devices and more particular relates to a method, apparatus and system for accessing an application across a plurality of computers.

### BACKGROUND

The evolution of computers is currently quite active in the mobile device environment. It is now well-known to including calendaring, contacts, and messaging functions in mobile devices. More recently, there has been a veritable explosion of the number and type of applications that are configured to the unique form factors and computing environments of mobile devices.

### BRIEF DESCRIPTION OF THE DRAWINGS

For a better understanding of the various embodiments described herein and to show more clearly how they may be carried into effect, reference will now be made, by way of example only, to the accompanying drawings in which:

FIG. 1 is a schematic representation of a system for accessing an application across a plurality of computers.

FIG. 2 is a representation of a front view of the mobile computing device of the system of FIG. 1.

FIG. 3 is a block diagram of the device shown in FIG. 1.

FIG. 4 is a representation of a variation of the mobile computing device of FIG. 1.

FIG. 5 is a block diagram showing a non-limiting example of the host application in FIG. 3.

FIG. 6 is a flow-chart depicting a method of installing a proxy application.

FIG. 7 shows an example of system 50 after installation of the proxy application according to the method of FIG. 6, using a variation of the block diagram in FIG. 5.

FIG. 8 shows a method of accessing an application across a plurality of computers.

FIG. 9 shows the client machine and device of FIG. 1 in isolation and in greater detail to illustrate an example of performance of certain blocks from the method of FIG. 8.

FIG. 10 shows the client machine and device of FIG. 9 to illustrate another example of performance of certain blocks from the method of FIG. 8.

FIG. 11 shows the client machine and device of FIG. 9 to illustrate another example of performance of certain blocks from the method of FIG. 8.

### DETAILED DESCRIPTION

An aspect of this specification provides a method for accessing an application across a plurality of computers comprising: establishing a direct connection between a client machine and a mobile computing device; said mobile computing device configured to execute a client-side application regardless of whether said direct connection is active; said mobile computing device further connectable to at least one server configured to host a networking application that is accessible by said client-side application; said mobile computing device further configured to execute a host application for accessing said client-side application; receiving a request at said host application via said direct connection to load a web page from a browser executing on said client machine; sending from said host application said web page to said browser from host application for generation on said browser receiving at said host application any input entered into said web page via said browser; updating at least a portion of said web page at said host application based on changes in a current state of said client-side application.

The application may comprise one of an email application, a contact manager application, a calendar application, a memopad application, a tasks application, an instant messaging application, or a social networking application.

The direct connection may comprise a proxy executing on said client machine configured to associate an address entered into said browser with said host application.

The networking application may be accessible via an encrypted connection between said mobile computing device and said server.

The host application may be configured to access said client-side application via an application plug-in for intermediating communications between said host application and said client-side application.

The mobile computing device may be configured to execute a plurality of client-side applications corresponding to a plurality of networking applications.

The host application may be configured to access each of said client-side applications via a respective application plug-in for intermediating communications therebetween.

Another aspect of this specification provides a method for accessing an application across a plurality of computers comprising: establishing a direct connection between a client machine and a mobile computing device; said mobile computing device configured to locally execute a client-side application regardless of whether said direct connection is active; said mobile computing device further connectable to at least one server configured to host a networking application that is accessible by said client-side application; said mobile computing device further configured to execute a host application for accessing said client-side application; opening a browser executing on said client machine; loading a web page into said browser from said host application via said direct connection; said web page comprising content corresponding to said client-side application; generating said web page on said browser; and, sending any input into said web page received at said client machine to said host application.

The method may further comprise repeating said loading, generating and sending to reflect changes to said web page.

The loading may comprise executing an open-get command to receive changes to said web page occurring exclusively on said client machine or said server.

Another aspect of this specification provides a computer readable medium comprising a plurality of programming instructions executable on a mobile computing device comprising one or more methods according to any of the foregoing.

Another aspect of this specification provides a mobile computing device for providing access to an application across a plurality of computers comprising: at least one network interface for establishing a direct connection between a client machine and said mobile computing device; a processor connected to said network interface configured to execute a client-side application regardless of whether said direct connection is active; said at least one network interface further connectable to at least one server configured to host a networking application that is accessible by said client-side application; said processor further configured to execute a host application for accessing said client-side application; said processor further configured to receive a request via said direct connection to load a web page from a browser executing on said client machine; said processor further configured to said web page to said browser for generation on said browser; said processor further configured to receive via said direct connection any input entered into said web page via said browser; and, said processor further configured to update at least a portion of said web page at said host application based on changes in a current state of said client-side application.

The application may comprise one of an email application, a contact manager application, a calendar application, a memopad application, a tasks application, an instant messaging application, or a social networking application.

The direct connection may comprise a proxy executing on said client machine configured to associate an address entered into said browser with said host application.

The networking application may be accessible via an encrypted connection between said mobile computing device and said server.

The host application may be configured to access said client-side application via an application plug-in for intermediating communications between said web service and said client-side application.

The processor may be configured to execute a plurality of client-side applications corresponding to a plurality of networking applications.

The web service may be configured to access each of said client-side applications via a respective application plug-in for intermediating communications therebetween.

The direct connection may be established by a Bluetooth™ pairing between said client machine and said mobile computing device.

The server and the client machine may connect through a core mobile telephone network.

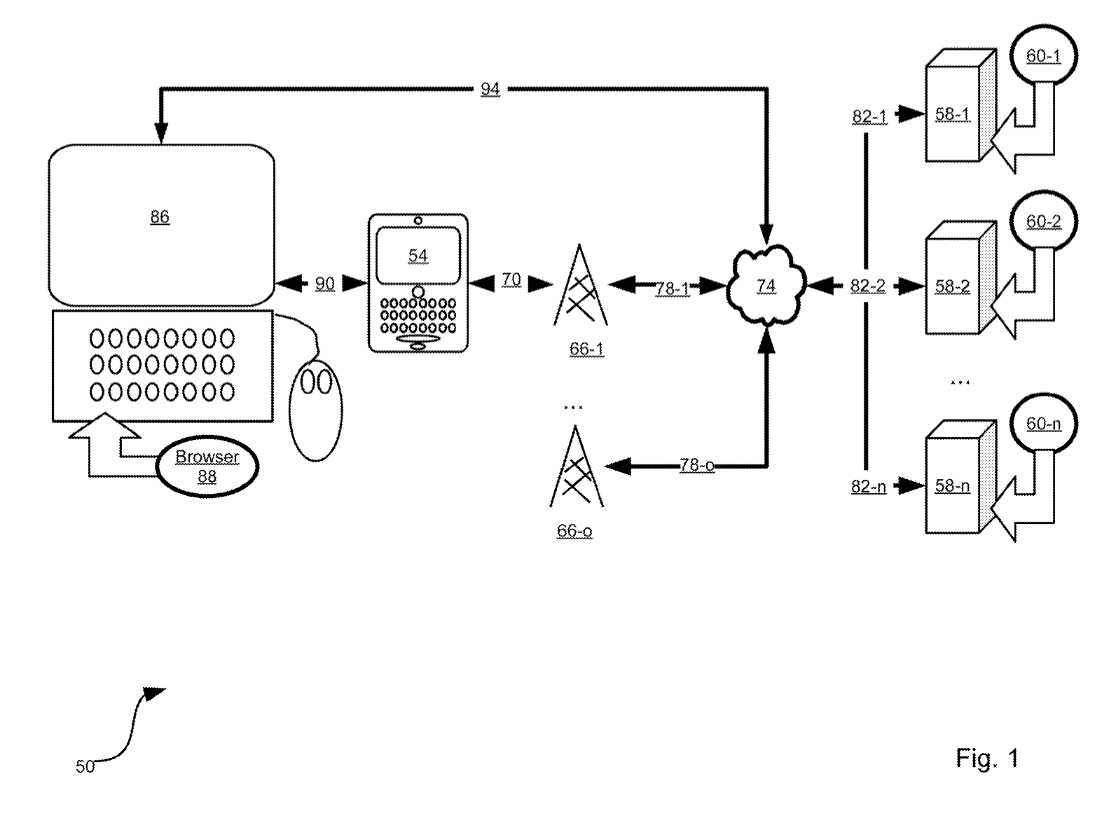

Referring now to FIG. 1, a system for accessing an application across a plurality of computers is indicated generally at 50. In a present embodiment system 50 comprises at least one computing device in the form of a mobile computing device 54 and at least one server 58-1, 58-2 . . . 58-n. (Generically, server 58, and collectively, servers 58. This nomenclature is used elsewhere herein).

A wireless link 70 connects mobile computing device 54 with one of a plurality of wireless base stations 66. In FIG. 1, mobile computing device 54 is shown as connecting to a first base station 66-1 via wireless link 70, but mobile computing device 54 can also connect to other base stations 66 in system 50. Backhaul links 78 connect each base station 66 to a network 74. Additional backhaul links 82 connect network 74 to each server 58.

Mobile computing device 54 can be any type of electronic device that can be used in a self-contained manner and to interact with content available on network 74. Interaction includes displaying of information on mobile computing device 54 as well as to receive input at mobile computing device 54 that can in turn be sent back over network 74. Mobile computing device 54 will be explained in greater detail below.

It should now be understood that the nature of network 74 and links 70, 78 and 82 associated therewith is not particularly limited and are, in general, based on any combination of architectures that will support interactions between mobile computing device 54 and servers 58. In a present embodiment network 74 includes the Internet as well as appropriate gateways and backhauls to links 78 and 82. For example, backhaul links 78 and backhaul links 82 can be based on a T1, T3, O3 or any other suitable wired or wireless connections. Accordingly, the links 78 and 82 between network 74 and the interconnected components are complementary to functional requirements of those components.

Link 70 may be based on, by way of non-limiting examples, a core mobile network infrastructure, such as, by way of non-limiting examples, one or more of Global System for Mobile communications (“GSM”); Code Division Multiple Access (“CDMA”); CDMA 2000;) 3G; or Evolution-Data Optimized or Evolution-Data (“EVDO”); or successors thereto or hybrids or combinations thereof; or on a wireless local area network (“WLAN”) infrastructures such as, by way of non-limiting examples, the Institute for Electrical and Electronic Engineers (“IEEE”) 802.11 Standard (and its variants) or Bluetooth or the like or hybrids or combinations thereof. Note that in an example variation of system 50 it is contemplated that link 70 may be a wired connection.

A client machine 86 also connects to mobile computing device 54 via a link 90. In a present example implementation, client machine 86 is a desktop, notebook, laptop, or tablet computer and link 90 is a direct connection effected wirelessly or wired. Where link 90 is wireless, then link 90 can be, for example, a Bluetooth™ or a peer-to-peer Wi-Fi connection between client machine 86 and mobile computing device 54. Where link 90 is wired, then link 90 can be, for example, a universal serial bus (USB) or Firewire connection. Those skilled in the art will now recognize other types of wired or wireless connections that can be used to effect a direct connection for link 90. In variations, link 90 can be effected indirectly through, for example, a local area network or a Wi-Fi network, or even through a wide area network such as network 74.

Client machine 86 is initially configured to maintain or execute at least a web browser application 88, and need not have direct access to network 74, though in some cases such a direct connection to network 74 would be possible through a link 94. Accordingly, client machine 86 can be based on any computing environment that provides web browsing functionality. For example, such a computing environment can be based on an Intel™ or AMD™ or other microprocessor, with accompanying volatile storage (e.g. random access memory) and non-volatile storage (e.g. Flash, Hard disc drive), read only memory (ROM), network interface card(s), video cards that connect to one or more displays, a keyboard, a mouse (or other pointing device). Any operating system may be used, including, for example, an operating system offered by Microsoft™, or a Linux™ operating system, or an operating system offered by Apple Computer, or an operating system offered by QNX. Browser application 86 can be any browser application can be used that is executable on a respective operating system, including Firefox™, Internet Explorer™, Chrome™, Opera™ or Safari™. Typically, though not necessarily, client machine 86 will have a display or a keyboard or both that are larger than that provided on mobile computing device 54. Client machine 86 may also have another configuration, such as a tablet computing device.

Servers 58 can be based on any well-known server environment including a module that houses one or more central processing units, volatile memory (e.g. random access memory), persistent memory (e.g. hard disk devices) and network interfaces to allow servers 58 to communicate over network 74. For example, each server 58 can be a ProLiant® Server from Hewlett-Packard Company, 3000 Hanover Street Palo Alto, Calif. 94304-1185 USA having a plurality of central processing units and having several gigabytes of random access memory. However, it is to be emphasized that this particular server is merely a non-limiting example, and a vast array of other types of computing environments for each server 58 is contemplated. Furthermore, it is contemplated that each server 58 may be implemented as a plurality of interconnected servers, in a so-called server farm, which are mirrored or otherwise configured for load balancing or failover or high availability or any or all of those.

As will be discussed further below, each server 58 maintains a different networking application 60. Networking applications 60 can be any application whereby a corresponding client-side application executes on mobile computing device 54 which accesses data or any other server functions on a given server 58. Networking applications can be, by way of non-limiting examples, personal information management applications, social networking applications, or messaging applications. Non-limiting examples of personal information management applications include calendaring and contact management applications. Non-limiting examples of social networking application 60 include Facebook™, Twitter™, LinkedIn™, and MySpace™ Networking applications 60 can also comprise messaging applications such email, BlackBerry Messenger, AOL instant messenger (AIM), Yahoo Messenger (YM), Google Talk (Gtalk), Lotus Connections, Windows Live Messenger. There are many others.

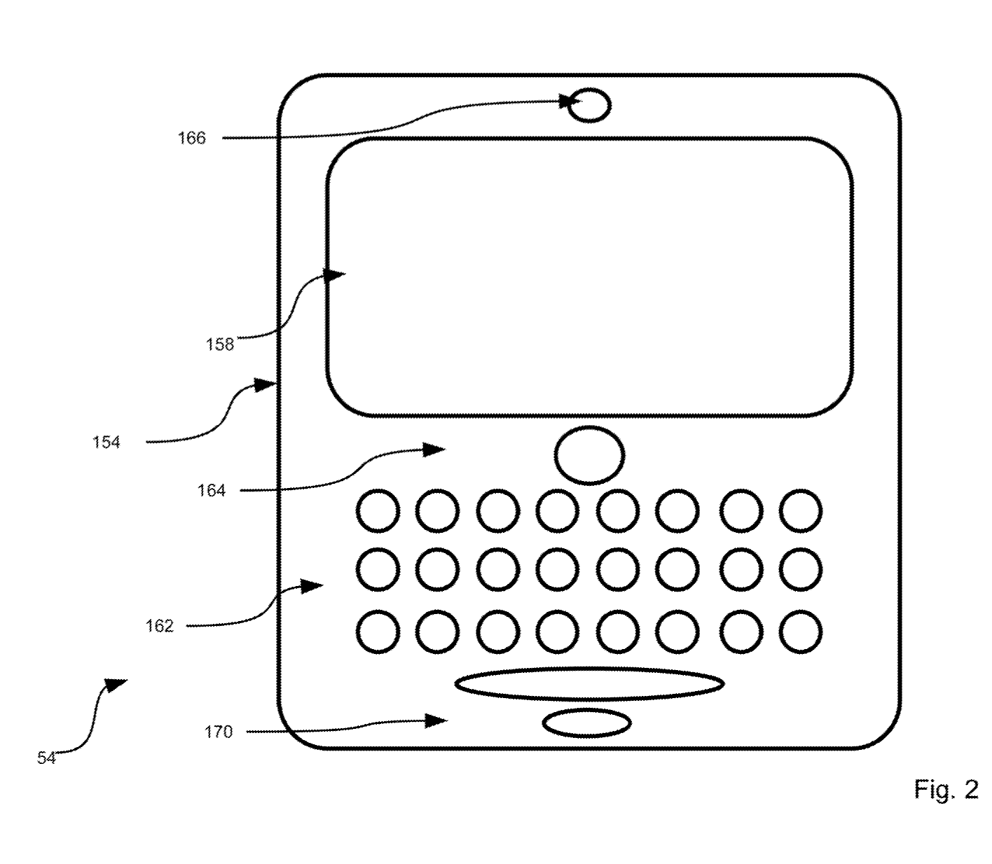

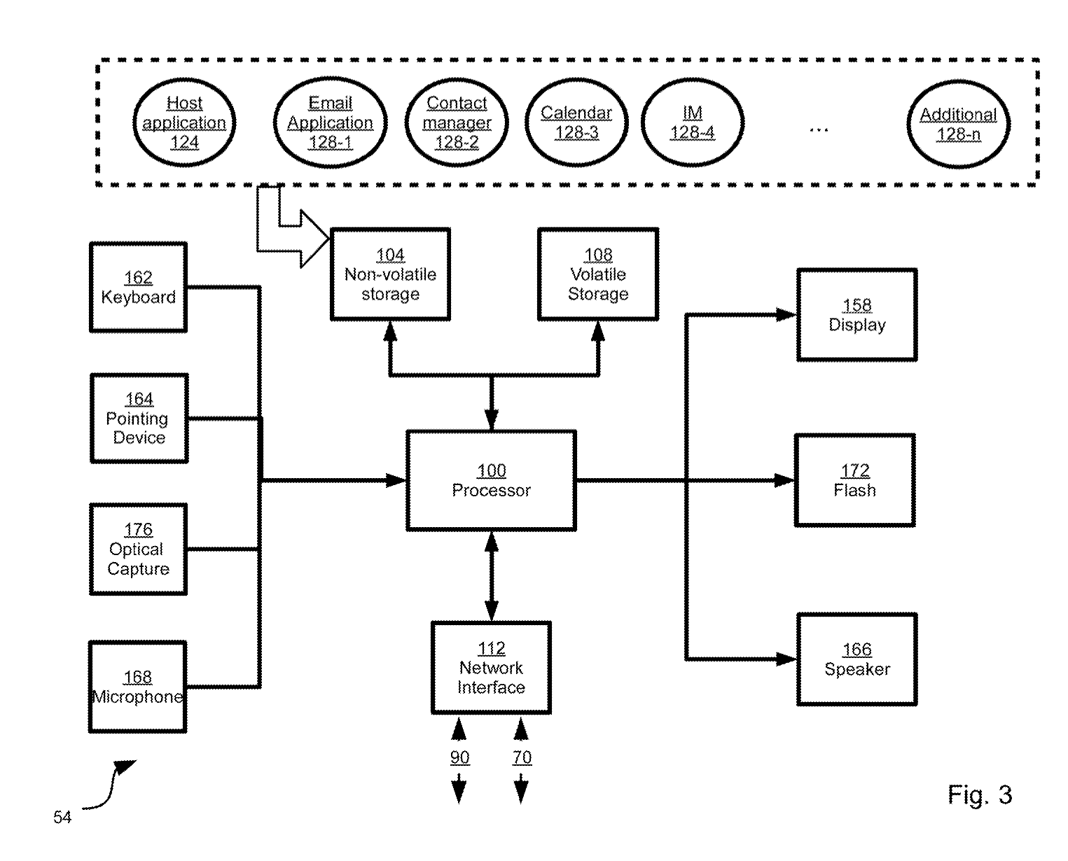

FIG. 2 and FIG. 3 show different views and representations of a non-limiting example of a mobile computing device 54 which can execute one or more applications as discussed in greater detail below. It is to be understood that mobile computing device 54 is an example, and it will be apparent to those skilled in the art that a variety of different electronic device structures are contemplated. Indeed variations on mobile computing device 54 can include, without limitation, a cellular telephone, a portable email paging device, a network enabled digital camera, a portable music player, a portable video player, a portable video game player, a laptop computer, a desktop computer, or any appropriately configured network enabled appliance.

Referring to FIG. 2, in a present, non-limiting example, device 54 comprises a chassis 154 that supports a display 158. Display 158 can comprise one or more light emitters such as an array of light emitting diodes (LED), liquid crystals, plasma cells, or organic light emitting diodes (OLED). Other types of light emitters are contemplated. Chassis 154 also support a keyboard 162. It is to be understood that this specification is not limited to any particular structure, spacing, pitch or shape of keyboard 162, and the depiction in FIG. 2 is an example. For example, full or reduced “QWERTY” keyboards are contemplated. Other types of keyboards are contemplated. (In variations, device 154 may also be a touch-screen device with no physical keyboard.) Device 154 also comprises a pointing device 164 which can be implemented as a touch-pad, joystick, trackball, track-wheel, or as a touch sensitive membrane on display 158. Device 154 may also comprise a speaker 166 for generating audio output, and a microphone 68 for receiving audio input.

FIG. 3 shows a schematic block diagram of the electronic components of device 154. It should be emphasized that the structure in FIG. 3 is an example. Device 154 includes a plurality of input devices which in a present embodiment includes keyboard 162, pointing device 64, and microphone 168 and an optical capture unit 176. Fewer, additional, or alternative input devices are contemplated. Input from keyboard 162, pointing device 164 and microphone 168 and optical capture unit 176 is received at a processor 100. Processor 100 can be configured to execute different programming instructions that can be responsive to the input received via input devices. To fulfill its programming functions, processor 100 is also configured to communicate with a non-volatile storage unit 104 (e.g. Erase Electronic Programmable Read Only Memory (“EEPROM”), Flash Memory) and a volatile storage unit 108 (e.g. random access memory (“RAM”)). Programming instructions that implement the functional teachings of device 154 as described herein are typically maintained, persistently, in non-volatile storage unit 104 and used by processor 100 which makes appropriate utilization of volatile storage 108 during the execution of such programming instructions.

Processor 100 in turn is also configured to control display 158, speaker 166 and flash 172, also in accordance with different programming instructions and optionally responsive to different input receive from the input devices. Fewer, additional, or alternative output devices are contemplated.

Processor 100 also connects to a network interface 112, which can be implemented in a present embodiment as one or more radios configured to communicate over link 70 and link 90. Network interface 112 can thus be generalized as a further input/output device that can be utilized by processor 100 to fulfill various programming instructions. It will be understood that interface 112 is configured to correspond with the network architecture that defines each link 70 and link 90. It is also contemplated each network interface 112 can include multiple radios to accommodate the different protocols that may be used to implement different types of links where the network architecture for each link 70 differs between base stations 66, or where link 90 may be based on different architectures. For example, link 90 may also be a wired link (e.g. USB) in which case it may not have a radio at all.

In a present embodiment, device 54 is also configured to maintain, within non-volatile storage 104, a host application 124, and one or more client applications 128 such as an email application 128-1, a contact manager application 128-2, a calendar application 128-3, an instant messenger application 128-4 or one or more of a plurality of additional applications 128-n. Non-limiting examples of additional applications 128 can comprise, without limitation, one or more of social networking client applications, e.g., Twitter, Facebook, MySpace, Linkedln; other applications associated with online communities e.g., Flickr, Gtalk, etc; document tools such as Google Docs. Any one or more of host application 124 and client applications 128 can be pre-stored in non-volatile storage 104 upon manufacture of device 54, or downloaded via network interface 112 and saved on non-volatile storage 104 at any time subsequent to manufacture of device 54. Each application 128 is also configured to interact with its corresponding network application 60 as needed.

Processor 100 is configured to execute each application 128, making use of input from input devices and controlling display 158 to generate output based on that input and according to the programming instructions of each application 128. In general, each application 128 can be based on any existing or future application 128 that can be executed entirely on a device such as device 54, even when link 90 is not active and device 54 is disconnected from client machine 86. For example, email application 54 can be a standard electronic mail application that is already commonly deployed on various devices such as device 54 and entirely usable on device 54, without any connection to client machine 86, and while accessing servers 58 as needed. Likewise contact manager application 128-2, calendar application 128-3, instant messenger application 128-4 and any of the additional applications 128-n can be based on such applications that are already commonly deployed, or may be deployed in the future, and entirely usable on device 54 without any connection to client machine 86, and while accessing servers 58 as needed.

Processor 100 is also configured to execute host application 124 to permit access to client applications 128 via client machine 86, when link 90 is active, as will be explained further below.

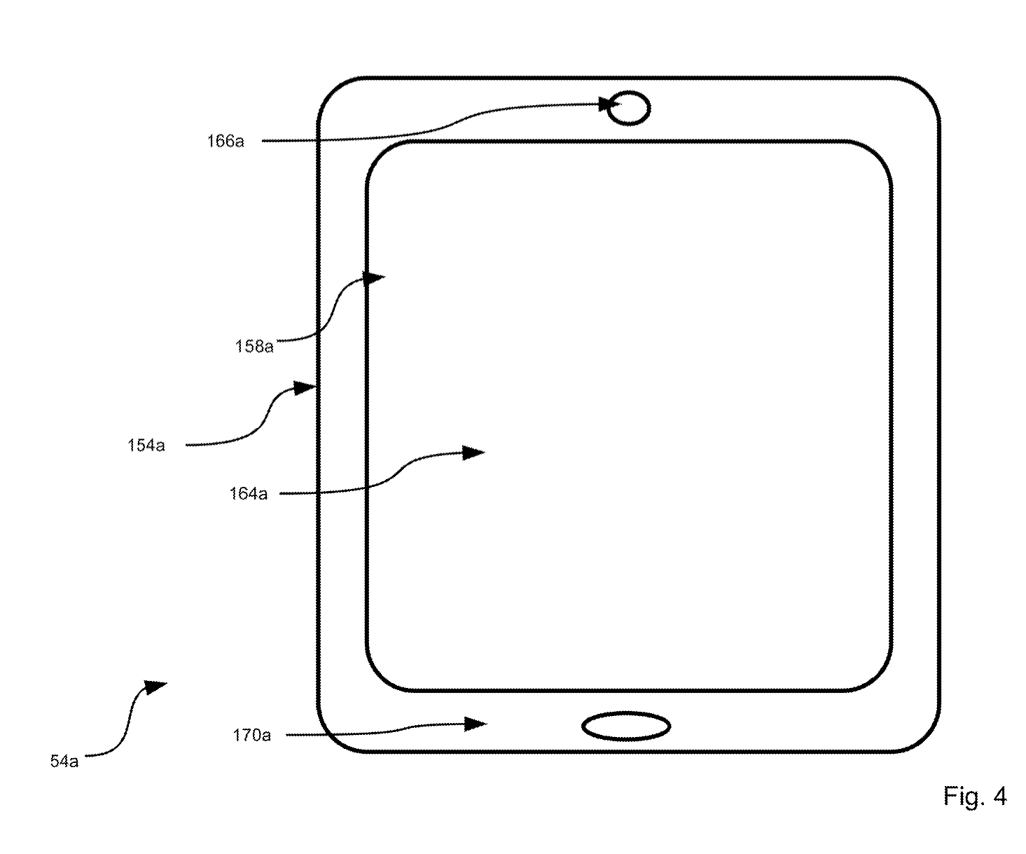

Referring briefly to FIG. 4, a variation on device 54 is indicated generally as device 54a. Device 54a comprises many of the same components as device 54, and therefore like components bear like references except followed by the suffix “a”. Of note is that device 54a excludes keyboard 162 and pointing device 164. Instead, device 54a comprises a touch screen 164a which provides the combined functionality of keyboard 162 and pointing device 164. Further variations on device 54 will now occur to those skilled in the art, but for convenience, further discussion of the present specification will focus on device 54 as described above. As will become apparent from further discussion herein, the lack of a full keyboard in device 54a presents certain limitations for providing input to device 54a, and those limitations may be mitigated by the present specification.

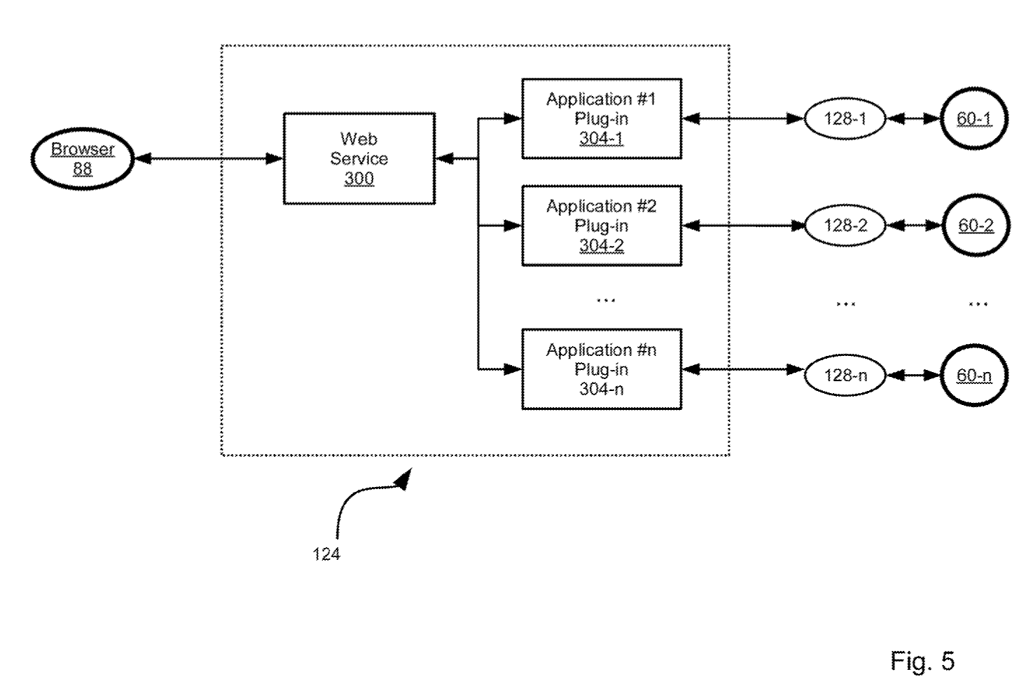

FIG. 5 shows a block diagram of an example an implementation of host application 124 and its virtual connections to browser 88 and applications 128. The virtual connections between applications 128 are also shown to applications 60. Those skilled in the art will now recognize that the components and connections in FIG. 5 can be implemented using the hardware structures shown in FIG. 1, or variations thereon. Host application 124 thus comprises a web service 300 and a plurality of application plug-ins 304. Web service 300 is configured to generate and serve content to browser 88, on behalf of each application 128 via respective application plug-ins 304. Application plug-ins 304 are configured to act as programming interfaces between web service 300 and applications 128. Accordingly, each application plug-in 304 is designed uniquely for its corresponding application 128, so that web service 300 can generate hyper-text markup language (HTML), as desired, and any other code (e.g. JavaScript files, Cascading Style Sheets) that are usable by browser 88, so that graphical interfaces can be generated on client machine 86 for each application 128. According to this implementation, no modification to each application 128 is needed in order to provide access to those applications 128 via browser 88. Instead, access to a particular application 128 can be provided on browser 88 by creating a plug-in 304 for that particular application 128. Alternatively, a plug-in 304 may be implemented as a component of a particular application 128.

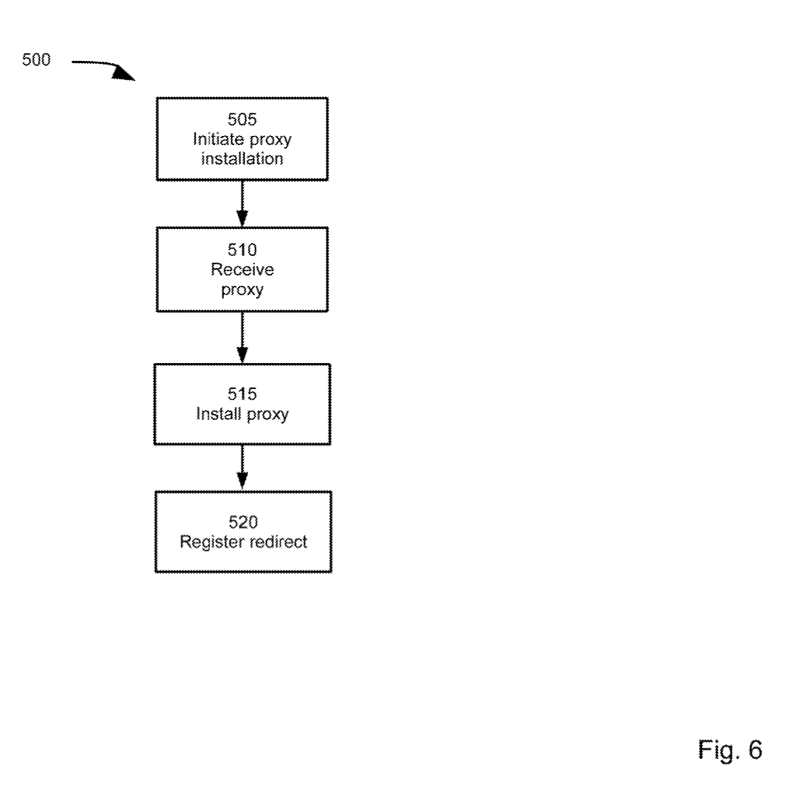

Referring now to FIG. 6, a flow-chart depicting a method for provisioning a client machine to interact with a mobile electronic device is indicated generally at 500. Method 500 can be implemented using system 50, and for purposes of explaining method 500 it will be assumed that method 500 is performed using system 50. However, it is to be understood that variations are contemplated to both method 500 and system 50 and such variations are within the scope of this specification. Method 500 is not strictly required, but in a present implementation method 500 provides a proxy on client machine 86 such that web service 300 is addressable and reachable from the address bar in browser 88. Method 500 also assumes that link 90 is a direct link between client machine 86 and mobile electronic device 54. Again, such a direct connection for link 90 can be a peer-to-peer Bluetooth™ connection whereby client machine 86 and device 54 are “paired” using known Bluetooth™ hardware and network protocols. Such a direct connection for link 90 can also be a USB cable connection. Other means for implementing link 90 will now occur to those skilled in the art. In a present implementation, it is assumed that link 90 is a Bluetooth™ connection.

Block 505 comprises receiving an instruction to install a proxy application. Block 505 can be implemented in different ways. One factor that affects how block 505 is implemented is the location where the installation file for the proxy application is stored. In one implementation, the proxy application is stored on a server (possibly one or more of servers 58, though not necessarily) connected to network 74, in which case installation initiation may be effected by entering a uniform resource locator (URL) into browser 88 that points to the network 74 address of the server that stores the proxy application. In another implementation, the proxy application is stored as a data file within persistent storage 104 of device 54. In this implementation, non-volatile storage 104 of device 54 is configured to appear as an external hard-disk when link 90 is active—this type of configuration being inherent in many operating systems and devices such as device 54, where link 90 is a USB connection. Thus, once device 54 appears as a hard-disk, the data file containing the proxy application can be downloaded via link 90 onto client machine 86. In variations, the proxy could be provided on a CD or other removable media.

Block 510 comprises receiving the proxy application for which installation was initiated at block 505. Where proxy application is stored on network 74, then block 510 comprises downloading the proxy application via network 74 and link 94. When proxy application is stored on device 54, then the proxy application is transferred via link 90 to client machine 86.

Those skilled in the art will now recognize other means of effecting block 505 and block 510.

Block 515 comprises installing the proxy application that was received at block 510. At this point it will be appreciated that the form in which proxy application is originally stored and received can vary according to the level of sophistication to be employed in the actual installation of the proxy application. It is presently contemplated that the proxy application will be an executable application that invokes an installation wizard, or the like, so that a simple series of key strokes (or other input sequence) on client machine 86 are all that is required to actually install the proxy application. However, proxy application can be received at block 510 in other forms.

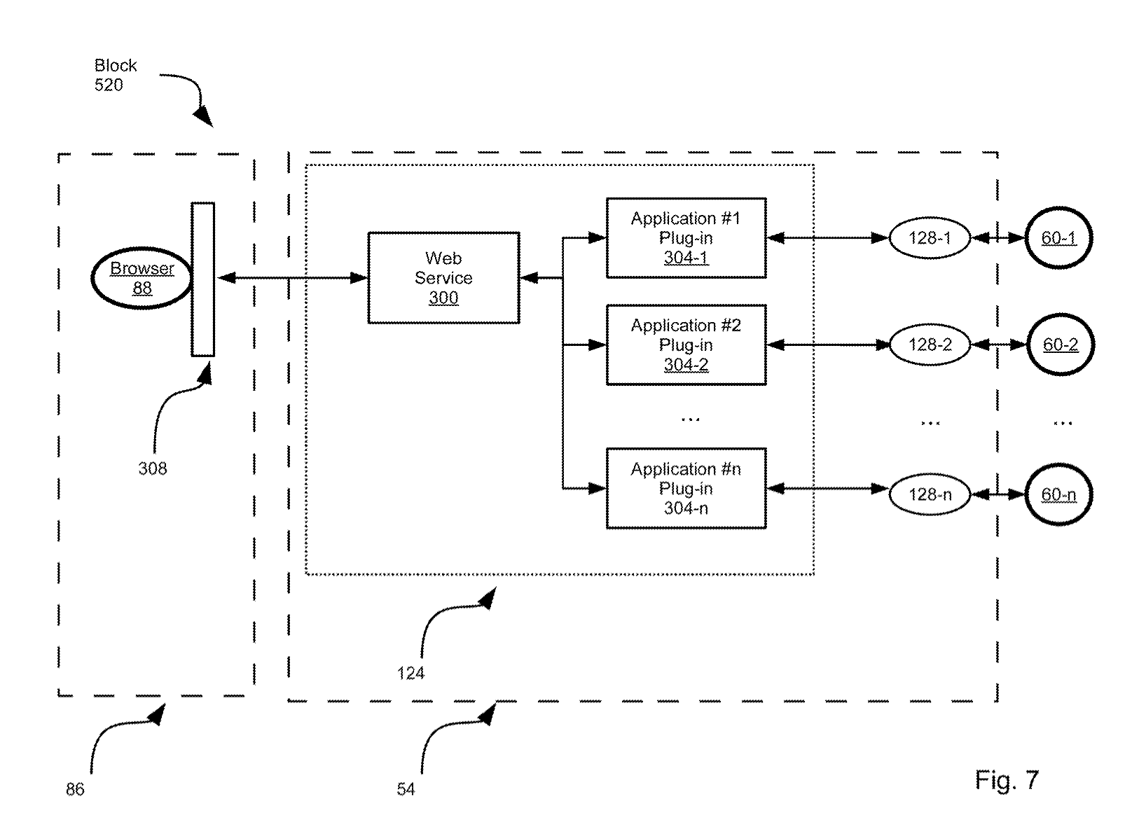

Block 520 comprises registering the proxy application installed at block 515. Such registration is local to the client machine and serves to identify a URL or Internet Protocol (IP) address redirect such that entry of that URL or IP addresses that causes browser 88 to access web service 300. A representation of portions of system 50 is shown in FIG. 7, which itself is a variation on FIG. 5. FIG. 7 is thus substantially the same as FIG. 5, except that a proxy application 308 is shown as being installed on client machine 86 and sitting between browser 88 and web service 300 on device 54. Expressed another way, proxy application 308 configures client machine 86 so that entry of a given URL or other address in the address bar of browser 88 directs browser 88 to connect with web service 300 and to generate a web page on the display of client machine 86 that corresponds to a web page being offered by web service 300. The term generate refers to any processing activity that results in control of the display by one or more processors in order to render the page on the display of the client. An example of such a URL may be, http://localhost, provided such a URL is not already reserved for another proxy application on client machine 86. Thus, upon entry of http://localhost, browser 88 will be directed to proxy 308 and in turn browser 88 will connect to web service 300. Returning to the example where link 90 is based on Bluetooth™, then proxy application 308 sits between browser 88 and the Bluetooth service and drivers executing on client machine 86, and forms a virtual connection with device 54 according to the Bluetooth pairing that has been registered on the Bluetooth service of device 54. In turn, web service 300 is configured to respond to HTTP requests received via the Bluetooth service that is resident on device 54.

At this point it is to be reiterated that method 500 and the use of proxy application 308 is not needed in all implementations contemplated by this specification, and accordingly, certain of the following discussions may not make reference to proxy application 308 and FIG. 7. However, it is also to be understood that the following discussion is also applicable to configurations that utilize proxy application 308. Also, in some configurations, the proxy application 308 may be pre-installed on client machine 86, so that method 500 may not be required.

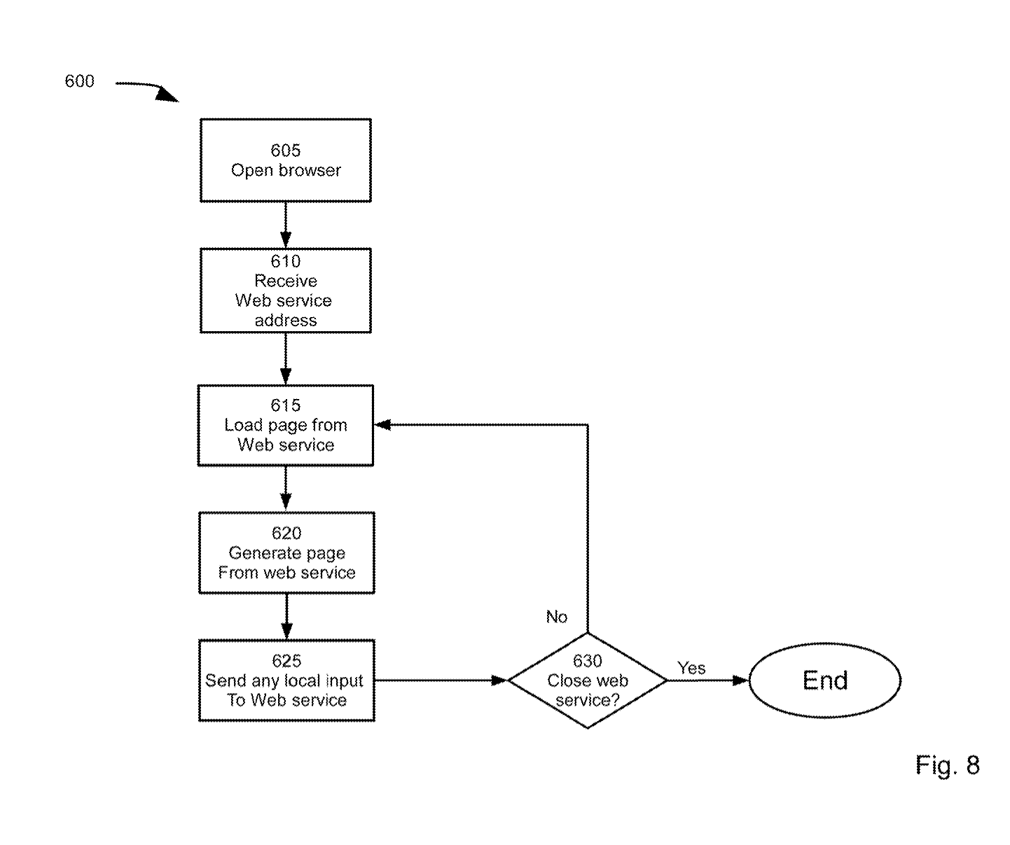

Referring now to FIG. 8, a flow-chart depicting a method for accessing an application across a plurality of computers is indicated generally at 600. Method 600 can be implemented using system 50, and for purposes of explaining method 600 it will be assumed that method 600 is performed using system 50. However, it is to be understood that variations are contemplated to both method 600 and system 50 and such variations are within the scope of this specification. Performance of method 600 presumes that link 90 is active between device 54 and client machine 86.

Block 605 comprises opening a web browser. In system 50, block 605 is effected at client machine 86 whereby browser 88 is opened in the usual manner. Block 610 comprises receiving a web services address. Block 610 is effected by typing an address (e.g. http://localhost) into the address bar of browser 88. In system 50, the address received at block 610 corresponds to the address web service 300 of host application 124. In variations, it is contemplated that system 50 may be configured so that browser 88 is automatically launched and directed to the appropriate address in a single step: for example via a desktop shortcut on client machine 86. In variations, the address bar of browser 88 may not be visible to the user.

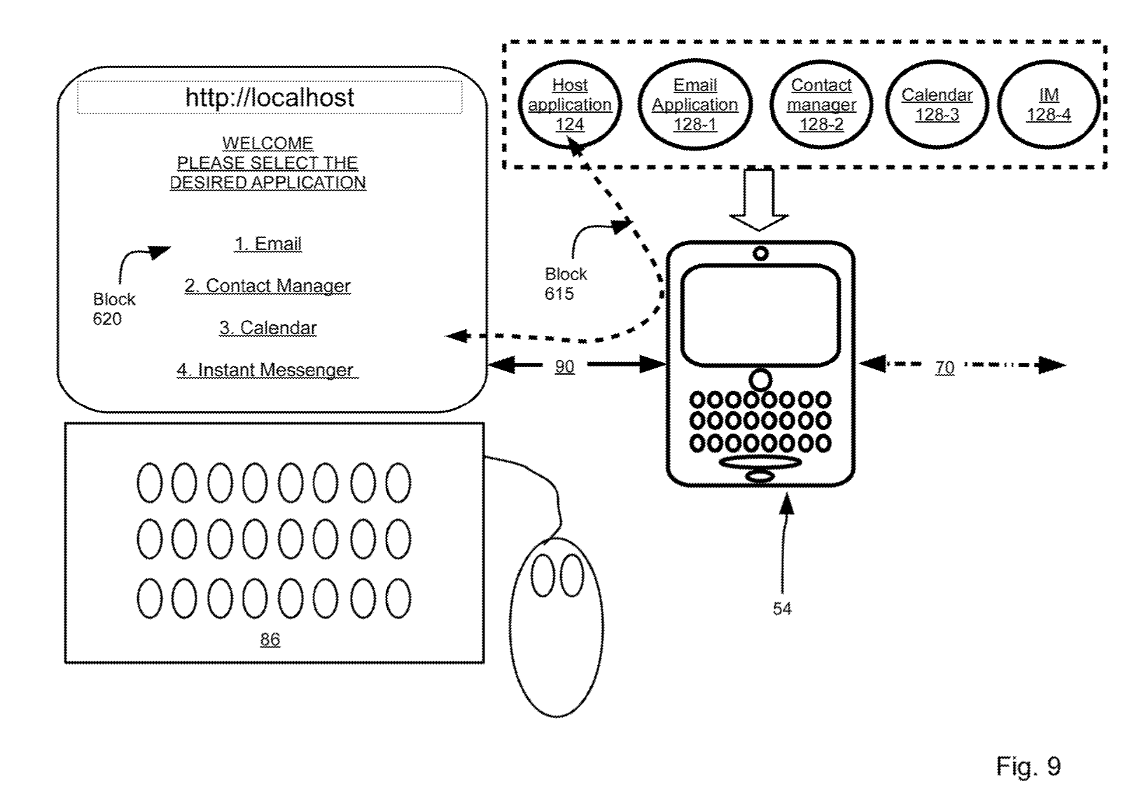

Block 615 comprises loading a web page from the web service. In system 50, and during the initial performance of block 615, block 615 can comprise loading a webpage in the form of a menu that can be used to select invocation of any one of applications 128. An example of performance of this initial performance of block 615 is shown in FIG. 9, where browser 88 is open on the display of client machine 86, and a URL pointing to the web service 300 of host application 124 is open. Block 620 comprises generating the web page that was loaded at block 615. As can be seen in FIG. 9, host application 124 is serving a menu web page, which offers web-based access to the applications 128 that are available on device 54. Thus, as shown on the display of client machine 86 in FIG. 9, menu item one reads “Email”, which is offering access to email application 128-1; menu item two reads “Contact Manager”, which is offering access to contact manager application 128-2; menu item three reads “Calendar”, which is offering access to contact manager application 128-3; and menu item four reads “Instant Messenger”, which is offering access to instant message application 128-4. For simplicity, application 128-n is not shown in FIG. 9.

Block 625 comprises sending any local input to the web service. Block 625 is effected through browser 88 which accepts local input from the keyboard or the mouse that is connected to client machine 86. As part of that locally received input, any input that is responsive to forms or links or other input that can be entered into the page generated at block 620 is sent to the web service that originally served the page generated at block 620.

According to the example in FIG. 9, input can be received that selects one of the four menu items being generated on the display of client machine 86. To give a specific example, it can be assumed that menu item one is selected, indicating an instruction to access email application 128-1. Again, such selection can be effected via keyboard input, or by bringing a cursor into focus over the desired selection using a mouse and then clicking the mouse to effect the selection, or via touch-screen input by touching the desired selection.

Block 630 comprises determining whether an instruction has been received to close the web service. Such an determination can be based on closing browser 88, or it can be based on entry of another URL in the address bar of browser 88, or it can based on any other instruction or event that instructs closing of the web service. A yes determination ends method 600.

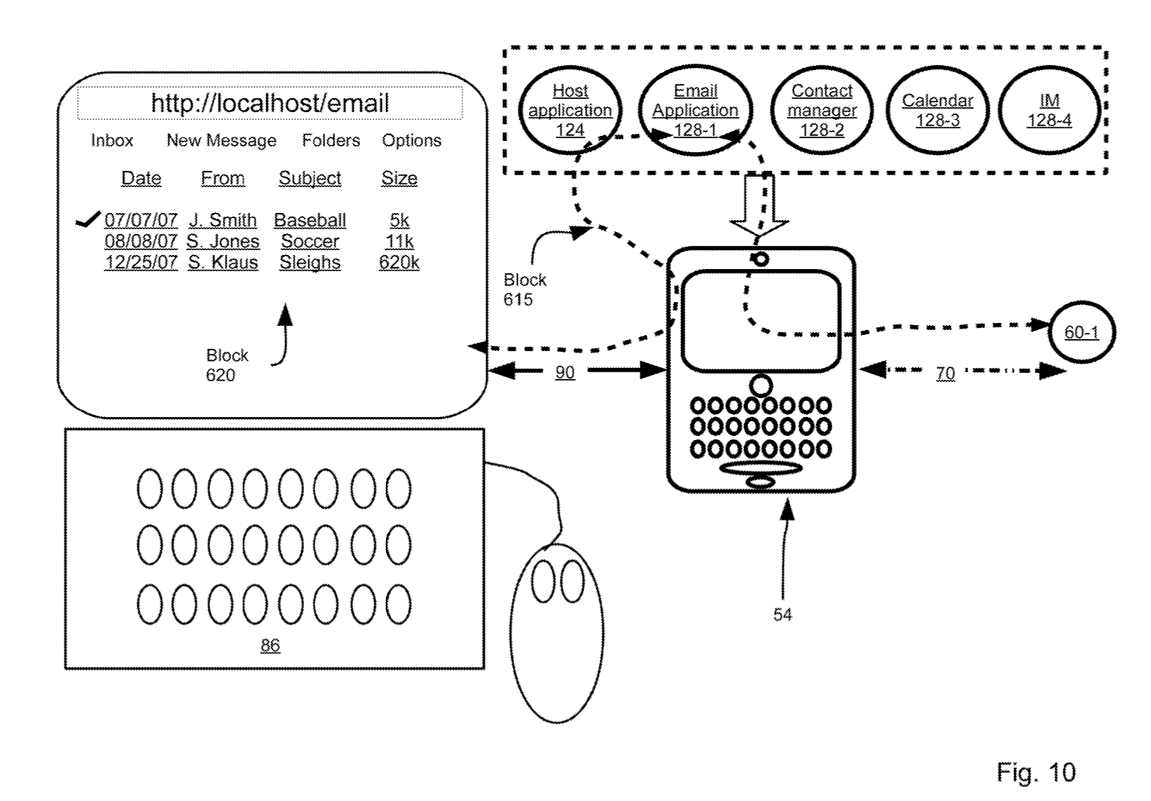

A no determination leads to a return to block 615 where any updates to the web page are loaded. Thereafter, method 600 continues performance as previously described. To give further explanation, and continuing with the example above where the menu selection for email was made, then during this performance of block 615 and block 620, a web page that provides web-access to email application 128-1 will be loaded and generated. This non-limiting example is shown in FIG. 10, where browser application 86 is shown as accessing the address http://localhostiemail, which is hosted by host application 124 in order to provide access to email application 128-1. When system 50 is configured using plug-ins 304, then block 615 and block 620 may likewise make appropriate use of plug-in 304-1 from FIG. 5 in order to generate the display shown in FIG. 10.

When the display shown in FIG. 10 is active, then block 525 can comprise receiving any input that relevant to email application 128-1. For example, such input may comprise selecting “New Message”, to thereby cause generation of a dialogue box on the display of client machine 86 which can be used to compose a new email message. In this example, a subsequent cycle through block 615 and block 620 would result in generation of such a dialogue box for composition of a new email message. Note that such generation is effected by host application 124 creating a web page with such a dialogue box, based on host application 124 interacting with email application 128-1, again making use of plug-in 304-1 from FIG. 5 when such a plug-in is employed. In variations, code to generate and display such a dialogue box may have been included in or referenced by the original web page, so a new web page may not need to be loaded in order for such a dialogue box to appear on the display.

In general, those skilled in the art will now appreciate that the data generated on the display of client machine 86 is under the control of device 54 and that client machine 86 is effectively a web-client while device 54 acts as a web-server. Furthermore, device 54 also makes of link 70 to access the appropriate server 58 and application 60, as part of determining what data to display on the display of client machine 86. Again, in the example of email, email application 128-1 accesses application 60-1 on server 58-1 in order to send new emails generated using client machine 86 and by the same token, email application 128-1 accesses application 60-1 in order to receive new emails, which are in turn generated on the display of client machine 86. Any other functions normally associated with email application 128-1 are likewise reflected on the display of client machine 86 and appropriate access to server 58-1 is effected accordingly. In addition to static web pages, browser 88 may be configured to receive code (e.g. JavaScript code) from host application 124. While executing this code, browser 88 may, from time to time, (e.g. possibly in response to user input or some other condition), request additional resources from host application 124 in order to update the page currently on the display without loading an entirely new page.

In order to configure browser 88 to respond to changes that occur on device 54, or on server 60, an “open-get” or equivalent programming function is employed so that browser 88 will automatically receive and respond to such changes. For example, assume that a new email message arrives on server 58-1, and that same new email message automatically arrives on device 54. The “open-get” function running on browser 88 will result in browser 88 also ascertaining the arrival of the new email message and result in the display of client machine 86 being updated accordingly to reflect the arrival of the new email message.

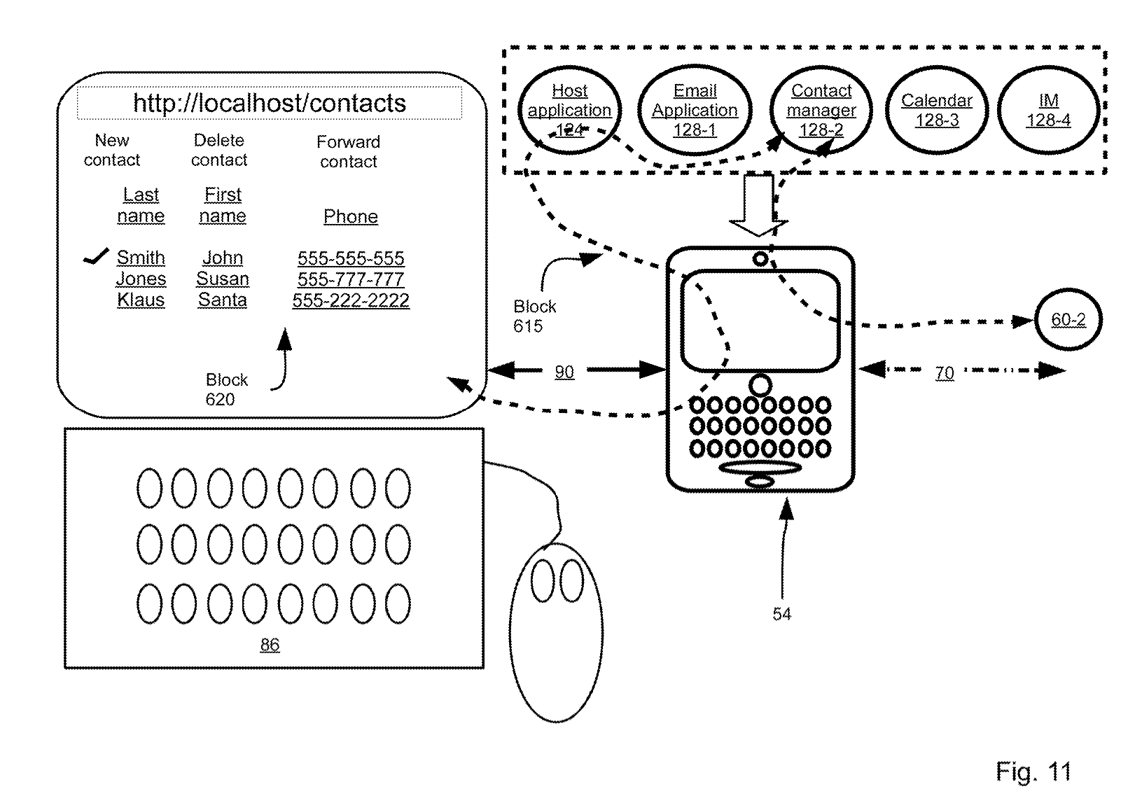

To help further illustrate the present specification, FIG. 11 shows a non-limiting example of the result of selecting contact manager application 128-2. In FIG. 11, the URL http://localhost/contacts is active and accordingly the web service 300 of host application 124 is accessing contact manager 128-2 so that input relative to contact manager application 128-2 can be received via client machine 86, and likewise, the display of client machine 86 can be controlled to display content relative to contact manager application 124. Again, changes to the contact database can be made client machine 86, or they can be made on device 54. Such changes can then be propagated to server 60-2 in the usual manner.

Those skilled in the art will now recognize how the foregoing can extend to calendar application 128-3, instant messenger application 128-4 and other applications 128-n.

Various advantages will now be apparent. For example, it is common that communications between device 54 and servers 58 may be effected via encrypted links. Accordingly, when link 90 is active, a full browsing experience, complete with full size display and full size keyboard, can be used to interact with various applications on device 54 but such interactions will be encrypted and secure. Furthermore, in certain situations link 94 may not be available, or of limited use, due to security restrictions, usage fees, or of low bandwidth and accordingly accessing data on servers 58 from client machine 96 via link 94 may not be possible or may be impractical. Nonetheless, it may be desired to use client machine 86 for such interactions, rather than device 54, due to the availability of the full keyboard, mouse and regular display that is available on client machine 86. Accordingly, the present specification may be most useful when device 54 is near enough to a given client machine 86 in order to establish link 90. Such client machines 86 are ubiquitous in air port lounges, hotel rooms, Internet cafes and other locations. Accordingly, for at least these reasons, this specification can be used to provide access to various applications from such client machines 86 in a novel, inventive and useful manner. It should also be noted that client machine 86 may have different configurations, and could include, for example, a tablet computer. In some examples, the link 90 may be an encrypted link.

Variations, subsets, enhancements and combinations of the foregoing are contemplated. For example, none of the screen shots shown in FIG. 9, FIG. 10 or FIG. 11 should be construed as being limiting as to exactly how data is generated on the display of client machine 86.

Furthermore, in relation to proxy application 308 in FIG. 7, it may be unlikely that publicly available client machines 86 will have proxy application 308 pre-installed, so as noted proxy application 308 may be stored in non-volatile storage 104 on client device 54. Further, it should be noted that non-volatile storage 104, itself, can be implemented as a removable storage media such as an SD card. Using a USB connection that proxy application 308 may be downloaded from the SD card to the client machine 86. Device 54 may also be configured so that it includes an auto-executable file which immediately executes on client machine 86 upon connection to client machine 86, and automatically copies proxy application 308 to the client machine 86. (Alternatively, device 54 can be configured so this installation is performed manually). After proxy application 308 has started, link 90 may be implemented via the USB connection or Bluetooth pairing or by other means. In the case of Bluetooth, the pairing step with client machine 86 could happen in a number of ways. For example, a scan for Bluetooth devices may be initiated from either device 54 or client machine 86 or both in the usual way. Alternatively, as part of proxy application 308, the client machine 86 may be configured to display a barcode that can be scanned using optical capture unit 176. The barcode data may comprise configuration information usable by device 54 to establish pairing with client machine 86.

When a “yes” decision is reached at block 630, client machine 86 may be configured to clear its browser cache to ensure that private data has been cleared from the client machine's 86 memory. The “yes” determination at block 630 may be reached a number of ways: device 54 may be manually logged off from client machine 86; link 90 may be terminated by unplugging a USB cable used to establish link 90; link 90 may be Bluetooth connection. An inactivity timer may be used to reach the “yes” determination at bock 630.

Alternatively, client machine 86 may operate in a no-cache mode when connected to device 54. In this mode, performance may be somewhat degraded since browser 88 may download content more often.

As noted above, device 54 runs a host application 124 that may be configured to listen to a real time communication channel, such an instant messaging conversation via instant message application 128-4. JavaScript may be executing on browser 88, such JavaScript having been provided by host application 124. This JavaScript maintains an open connection with the host application 124. When an event occurs in application 128-4, it is returned to the JavaScript so that corresponding changes occur on the display of client machine 86 under the control over browser 88. If an instant message reply is sent from the browser 88, then a separate parallel connection is opened and the commands are sent to host application 124 which then injects them into the ongoing conversation within instant message application 128-4.

In general, it can be noted that there are many applications 128 (with corresponding data sources and networking applications 60) on devices like device 54, including without limitation email, contacts, calendar, etc. Using this specification, each application 60 and its data may be rendered using browser 88 in a customized manner. Also, newly-installed and newly-created applications 128 may be readily added as available through browser 88 by creating a new application plug-in 304 for each new application 128. Host application 124 is configured to allow for ongoing registrations of new plug-ins 304. In effect, device 54 provides an application programming interface (API) associated with host application 124 that allows any application 128 running on the device 54 to register as a data source. Each application 128 can be assigned its own URL prefix and a handler class that implements a particular interface. All hypertext transfer protocol (HTTP) requests from client machine 86 for URLs with that prefix may be given to the handler class to be processed. The HTTP handler may respond to each request in any way that it sees fit, so it is in control of the data rendering. Because registration of applications 128 with host application may be dynamic, it is not needed to compile host application 124 to be limited to only those applications 128 installed at the same time as host application 124 is installed. Newly-installed applications can register at which point they will dynamically appear as being available through browser 88. Host application 124 can also dynamically enumerate all of the registered applications 128 at the time of creating a menu screen such as the menu screen shown in FIG. 9.

Other variations, combinations, and subsets will now occur to those skilled in the art.

1. A method in a mobile computing device, the method comprising:
running a user application corresponding to a network application maintained at a server and accessed via a network;
establishing a direct connection between the mobile computing device and a client machine, the mobile computing device configured to serve information associated with the user application to the client machine;
receiving, at the mobile computing device via the direct connection, a request for information associated with the user application;
sending from the mobile computing device the information to the client machine; and
receiving an input associated with the user application, the input received from the client machine via the direct connection.

2. The method of claim 1 wherein the user application comprises one or more of an email application, a contact manager application, a calendar application, an instant messaging application, or a social networking application.

3. The method of claim 1 wherein the user application comprises one or more of a memopad application or a tasks application.

4. The method of claim 1 wherein the direct connection includes communication with a proxy executing on the client machine, the proxy configured to facilitate communication between the client machine and the mobile computing device.

5. The method of claim 1 wherein the direct connection comprises a direct link between the client machine and the mobile computing device.

6. The method of claim 5 wherein the direct link comprises one of a peer-to-peer connection, a short-range radio frequency connection, a paired connection, or a cable connection.

7. The method of claim 1 wherein the user application accesses the network application via an encrypted connection between the mobile computing device and the server.

8. The method of claim 1, wherein establishing the direct connection between the mobile computing device and the client machine comprises establishing an encrypted link.

9. The method of claim 1 wherein the mobile computing device provides said information to the client machine using an application plug-in that communicates with the user application.

10. The method of claim 1 wherein the mobile computing device is configured to execute a plurality of user applications corresponding to a plurality of network applications.

11. The method of claim 10 wherein the mobile computing device comprises a host application configured to access each of the plurality of user applications using a respective application plug-in.

12. The method of claim 1 wherein establishing the direct connection between the mobile computing device and the client machine includes scanning a barcode displayed on the client machine, the barcode specifying configuration information for the direct connection.

13. The method of claim 1, wherein the mobile computing device is configured to run the user application regardless of whether the direct connection is active.

14. The method of claim 1, wherein the information associated with the user application is sent in the form of a web page.

15. The method of claim 14, further comprising updating at least a portion of the web page based on changes in a current state of the user application.

16. The method of claim 14, wherein the information associated with the user application is configured to be presented on a browser of the client machine.

17. A method in a client machine, the method comprising:
establishing a direct connection between the client machine and a mobile computing device;
executing a browser on the client machine;
sending, to the mobile computing device via the direct connection, a request for information associated with a user application running on the mobile computing device;
receiving the information requested;
displaying the information using the browser;
receiving, at the client machine, an input associated with the user application; and
sending the input to the mobile computing device via the direct connection.

18. The method of claim 17 wherein the information comprises a web page.

19. The method of claim 18 further comprising repeating the operations of sending the request, receiving the information, and displaying the information to reflect changes to the web page.

20. The method of claim 18, wherein the user application at the mobile computing device is associated with a corresponding network application maintained at a server accessible by the mobile computing device.

21. The method of claim 18 wherein sending the request comprises sending an open-get request so as to receive changes to the web page occurring on the mobile computing device.

22. A mobile computing device comprising:
at least one network interface for establishing a direct connection between the mobile computing device and a client machine;
a processor connected to the network interface and configured to run a user application corresponding to a network application maintained at a server and accessed via a network;
the processor further configured to receive, via the direction connection, a request for information associated with the user application;
the processor further configured to cause the information to be sent to the client machine; and
the processor further configured to receive via the direct connection an input associated with the user application.

23. The mobile computing device of claim 22 wherein the user application comprises one of an email application, a contact manager application, a calendar application, a memopad application, a tasks application, an instant messaging application, or a social networking application.

24. The mobile computing device of claim 22 wherein the direct connection includes communication with a proxy executing on the client machine, the proxy configured to facilitate communication between the client machine and the mobile computing device.

25. The mobile computing device of claim 22 wherein the server application is accessible by the mobile computing device via an encrypted connection.

26. The mobile computing device of claim 22 wherein the processor is further configured to access the information from the user application via an application plug-in.

27. The mobile computing device of claim 22 wherein the processor is configured to execute a plurality of user applications corresponding to a plurality of network applications.

28. The mobile computing device of claim 27 wherein a web service accesses each of the plurality of user applications using a respective application plug-in.

29. The mobile computing device of claim 22 wherein the direct connection is established by one of a peer-to-peer connection, a short-range radio frequency connection, a paired connection, or a cable connection between the client machine and the mobile computing device.

30. The mobile computing device of claim 22 wherein the server application is accessed by the mobile computing device through a mobile telephone network.

31. The mobile computing device of claim 22, wherein the processor is further configured to update at least a portion of the information sent to the client machine based on changes in a current state of the user application.

32. A computer readable medium comprising a plurality of programming instructions executable on a mobile computing device, the method comprising:
running a user application corresponding to a network application maintained at a server and accessed via a network;
establishing a direct connection between the mobile computing device and a client machine, the mobile computing device configured to serve information associated with the user application to the client machine;
receiving, at the mobile computing device via the direct connection, a request for information associated with the user application;
sending from the mobile computing device the information to the client machine; and
receiving an input associated with the user application, the input received from the client machine via the direct connection.
